(19) United States
(12) Patent Application Publication
(10) Pub. No.: US 2025/0067476 A1
(43) Pub. Date: Feb. 27, 2025

(54) SOLAR ENERGY COLLECTOR

(71) Applicant: SUNDRACO POWER INC., Edmonton (CA)

(72) Inventor: Robert DE CHAZAL, Edmonton (CA)

(21) Appl. No.: 18/728,551

(22) PCT Filed: Jan. 16, 2023
(86) PCT No.: PCT/CA2023/050041

§ 371 Date: Jul. 12, 2024

Related U.S. Application Data
(60) Provisional application No. 63/299,770, filed on Jan. 14, 2022.
(60) Provisional application No. 63/408,298, filed on Sep. 20, 2022.

(51) Int. Cl. F24S 10/75; F24S 20/20; F24S 23/74

(52) U.S. Cl. CPC F24S 10/75; F24S 20/20; F24S 23/74

(57) ABSTRACT

A solar energy collection system includes (a) an elongate solar collector unit with dual opposed elongate, hemi-parabolic mirrors each having a linear focus line; (b) an elongate receiver having two linear gaps, each of which lies along a focus lines of one mirror, and including a heat pipe and a heat transfer structure to heat a heat transfer fluid within the heat pipe with solar energy; and (c) a subsystem configured to move the heat transfer fluid through the receiver.

### FIELD OF THE INVENTION

The present invention relates generally to systems and methods for collecting and concentrating heat energy from solar radiation, and delivering it for storage and/or use in electrical power generation, industrial systems, and/or space heating.

### BACKGROUND

Parabolic troughs are used as solar thermal collectors, which are straight in one horizontal dimension, and curved as a parabola in the other two dimensions. These troughs are generally symmetrical and sunlight which arrives at the mirror parallel to its plane of symmetry is focused along a focal line.

The trough is most often aligned on a north-south axis, and rotated to track the sun as it moves across the sky each day.

The reflected sunlight is focused on a tube or conduit coincident with the focal line, heating a fluid within the tube. Thermal oil is typically used as a thermal fluid and runs through the tube to absorb the concentrated sunlight. This increases the temperature of the oil to some 400° C. The thermal fluid may then be used to heat energy storage devices, drive industrial processes, and/or power heat engines to create electricity.

There is a global need to be able to store abundantly available, but intermittent solar energy. Attractive energy storage efficiencies and times are currently available in comparatively inexpensive, packed-bed heat storage devices. The capacity of packed beds to store heat exceeds the operating temperatures of conventional concentrated solar energy (CSP) storage technology which uses the pairing of thermal oils and molten salts. The first are limited to around 400° C., the second to 560° C.

For a variety of reasons familiar to those skilled in the art, packed-beds require a gaseous thermal fluid to be efficient, rather than a liquid one. Packed-beds principally comprise high-temperature-resistant, particulate materials, forming a contained, porous body which gases can readily penetrate. High temperatures produce higher energy density in storage and longer storage times. However, mainly because gases have low heat capacities and therefore require the movement of large volumes, the challenges to their use have generally discouraged innovation in this specific field.

There is a need in the art for collectors of useable energy from the concentration of solar radiation operating at temperatures beyond the limits of current thermal liquids, where significant efficiencies may be achieved, not only in collection, but in storage and use of the product, as well.

### SUMMARY OF THE INVENTION

In one aspect, disclosed is a solar energy collection system comprising:
(a) a solar collector unit comprising a horizontally elongate, parabolic reflector having a linear focus line;
(b) an elongate receiver which lies along the focus line of the reflector; and
(c) a subsystem configured to move a gaseous heat transfer fluid through the receiver.

In some embodiments, the parabolic reflector has a cross-section of a segment of a parabola, which segment is located on one or both sides of the plane of symmetry of said parabola. In preferred embodiments, the reflector comprises a plurality of rectangular mirrors arrayed in vertical columns and horizontal rows, each mirror has a curved cross-section occupying a unique position of said segment such that collectively the cross-sections of a vertical row of the mirrors complete a trace of said segment of a parabola. The mirrors are supported independently by a common structure, which independent mirror supports permit each mirror to expand and contract without restraint, and to be aligned independently so as to have its focus line fall at a desired location, generally coincident with the focus line of all other mirrors in the reflector.

In some embodiments, the receiver is a solar to heat transfer fluid energy exchanger which defines a one or more internal passages through which the heat transfer fluid passes. To heat the heat transfer fluid, concentrated solar energy from the reflector is directed into a conduit positioned within the receiver, which is preferably a cylinder. In preferred embodiments, said cylinder has a longitudinal opening aligned with the focus line, through which concentrated irradiation passes in order to strike and heat a heat exchanger. The conduit may comprise surface modifications to enhance heat conduction into the heart of the receiver. The receiver may be shaped to optimize energy transfer and/or retention.

In preferred embodiments, the receiver comprises at least one insulating layer and/or a reflective layer to reduce conductive and radiant heat loss.

In preferred embodiments, the receiver defines a countercurrent flow in a separate passage within the receiver. Relatively cooler fluid returning from a fluid reservoir or an energy extraction system passes through a pipe which may form an integral part of the receiver, which pipe delivers the fluid to the conduit harbouring the heat exchanger.

The heat transfer fluid is a gas, such as nitrogen, carbon dioxide, or air.

In some embodiments, the receiver further comprises air mixers within the central passage.

In some embodiments, the solar collection unit is aligned from east to west, and further comprises a subsystem for tracking the elevation of the sun and adjusting the position of the solar collection unit accordingly. In some embodiments, the solar collection unit is aligned north to south and further comprises a subsystem for tracking the azimuth of the sun and adjusting the position of the solar collection unit accordingly.

In preferred embodiments, the solar collection unit is operatively connected to a control system configured to control the flow rate of heat transfer fluid through the receiver.

In another aspect, disclosed is an elongate solar energy receiver, configured to receive solar energy from a parabolic reflector which creates a linear focal line, the receiver comprising:
(a) a conduit defining a central hot gas flow path, having a central vertical support plate and defining at least one, preferably two linear gaps in the conduit on opposing sides of the support plate;
(b) a support structure supporting a lower edge of the support plate configured to transfer load to a receiver support structure;
(c) one or two semi-cylindrical radiation receivers having an external surface for absorbing solar energy, the receiver aligned with the linear gap to create an insolation plenum along the length of the receiver;
(d) a heat exchanging structure attached to an internal surface of the receiver, the structure comprising a plurality of heat transfer fins projecting into the heat pipe.

In some embodiments, the heat exchanging structure heat transfer fins comprise outer fins which curve towards each other to form a partially enclosed space between them.

In some embodiments, the solar energy receiver will have some or all of the features described below. If not all features are included, a receiver of the present invention may comprise any combination of features, without being limited to any particular combination which may be described or illustrated.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted is but one of a number of possible arrangements utilizing the fundamental concepts of the present invention.

FIGS. 1.1 and 1.2 are schematic depictions of solar collection unit(s) of one embodiment. FIG. 1.3 is a schematic depiction of the flow of heat transfer fluid through one embodiment of the system.

FIGS. 2.1 to 2.3 are views of a Mirror Panel Array.

FIGS. 3.1 to 3.5 are views of embodiments of the attachment structures for Mirror Panels.

FIG. 4.1 is a view showing the relationship between a Solar Mirror Array, as receiver, and incoming solar irradiance. FIG. 4.2 is a close-up cross-section of a receiver in relation to the focal lines of concentrated irradiance. FIG. 4.3 are views of a receiver, its components, and functions. FIG. 4.4 is a view of a receiver showing a variety of radiation paths caused by the receiver. FIG. 4.5 are views of a receiver and the function of a static mixer. FIG. 4.6 is a view of a receiver showing the function of entry caps.

FIG. 5.1 is a schematic image of a sunspot. FIG. 5.2 is a view showing irradiance distribution in a paraboloid concentrating system. FIG. 5.3 are views showing the relationship of incoming concentrated irradiance and the entry to the receiver's heat exchanger.

### DETAILED DESCRIPTION

Before exemplary embodiments are described below, it is to be understood that the claimed invention is not limited to particular embodiments described, as such may vary. It is also to be understood that the terminology used herein is for the purpose of describing particular embodiments only, and is not intended to be limiting, since the scope of the present invention will be limited only by the appended claims.

As used herein, the terms “vertical” and “horizontal” are used to describe the relative positioning, orientation or direction of certain elements, based on a substantially horizontal array, where the parabolic focal line is substantially horizontal. The present invention is not restricted to any one orientation, however, so these terms are not intended to be absolute limitations.

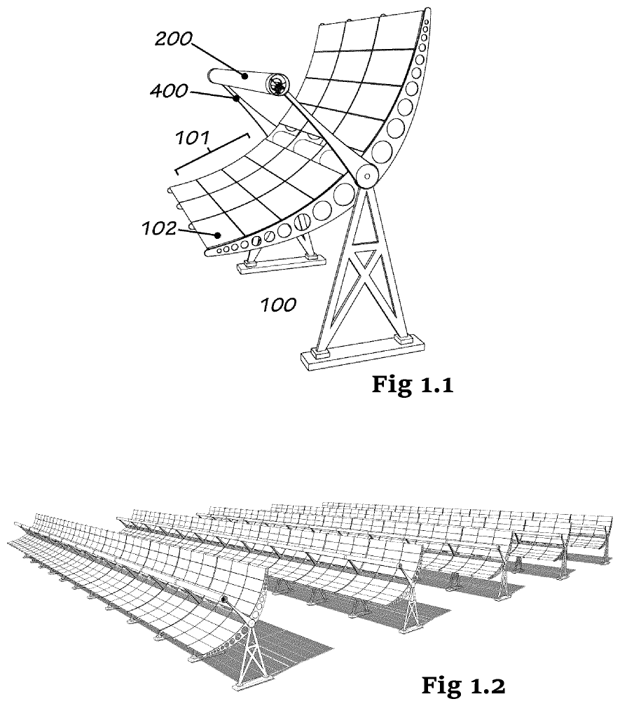

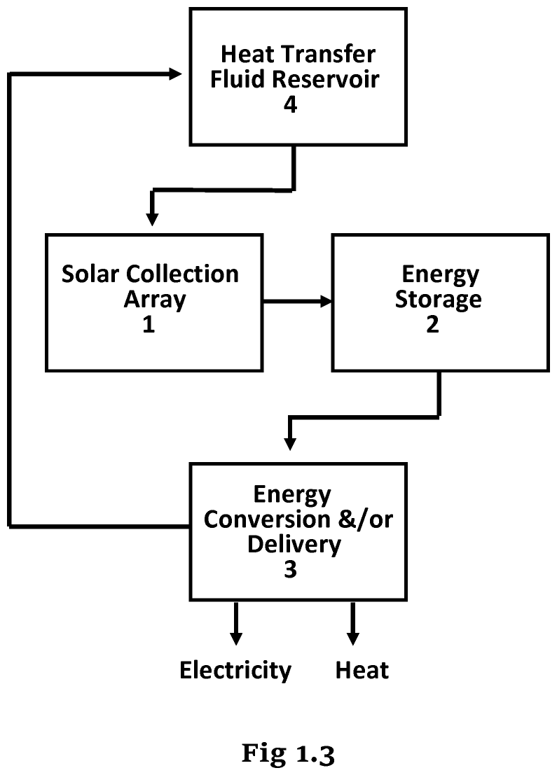

Disclosed herein are embodiments of a concentrated solar power collection system. One embodiment of a solar collection unit (SCU) 100 is illustrated in FIG. 1.1. In FIG. 1.2, an array of four rows of SCUs are shown, each comprising a parabolic reflector having one or more horizontal focal lines. The front row of SCUs comprises 10 SCUs connected in series.

By using parabolic mirrors, the SCU 100 is capable of concentrating solar irradiation, the energy of which is transferred to a gaseous heat transfer fluid. This heat energy may then be used, for example, to generate steam for a steam turbine generator, or stored for later use in different applications and systems.

The system comprises a subsystem configured to move the heat transfer fluid at a desired rate. As shown schematically in FIG. 1.3, one embodiment of a subsystem may comprise, at least one solar collection array 1, energy storage 2, an energy conversion and/or delivery system 3, and a heat transfer fluid reservoir 4. The heat transfer fluid is pumped through the system using at least one pump (not shown). Multiple SCUs 100 may be connected in series and/or in parallel to form the array. Various piping, pumps, valves and other equipment necessary for proper circulation of the heat transfer fluid will be apparent to those skilled in the art.

In preferred embodiments, the heat transfer fluid is a gas. Amongst other advantages, gases require much less energy to deal with elevation changes which introduce hydrostatic head pressure with liquids. The use of a gas as a heat transfer fluid thus permits installations with elevation changes, for example, to be built on a hillside to improve collection and the use of land.

### The Solar Collection Unit (SCU)

A solar collection system may comprise an array of SCUs 100, arrayed in parallel and/or series, as shown in FIG. 1.2. This modularity is a feature of the invention and provides valuable flexibility in responding to the amount of available insolation in a particular location or installation.

Unlike conventional solar energy collectors, the SCU 100 does not irradiate broadly the outside surface of a receiver 200, but focuses its collected energy into an elongate heat exchanger 220 positioned within a conduit carrying the thermal fluid, as described in further detail below. In preferred embodiments, the parabolic trough mirrors focus the reflected sun's image, or sunspot, as along a theoretical focal line 222X proximal and parallel to a gap in the wall of the heat exchanger carrying the heat transfer fluid. In some embodiments, it is beneficial to focus the sunspot as tightly as physically possible.

The elongate heat exchanger 223 is a prism which may have a generally circular or round cross-section (i.e. generally cylindrical) and may have various surface modifications, such as fins, to increase the physical contact between the heat exchanger and the heat transfer fluid. Solar insolation gains entry to the inside of the heat exchanger by way of a gap in the wall of the receiver, which runs the length of the receiver 200, in order to irradiate the interior of the heat exchanger 223.

In different embodiments, the invention may comprise any one or any combination of two or more of the following elements, and any element may itself comprise any one or a combination of two or more features described in respect of the elements below.

### The Mirror Panel Array (MPA)

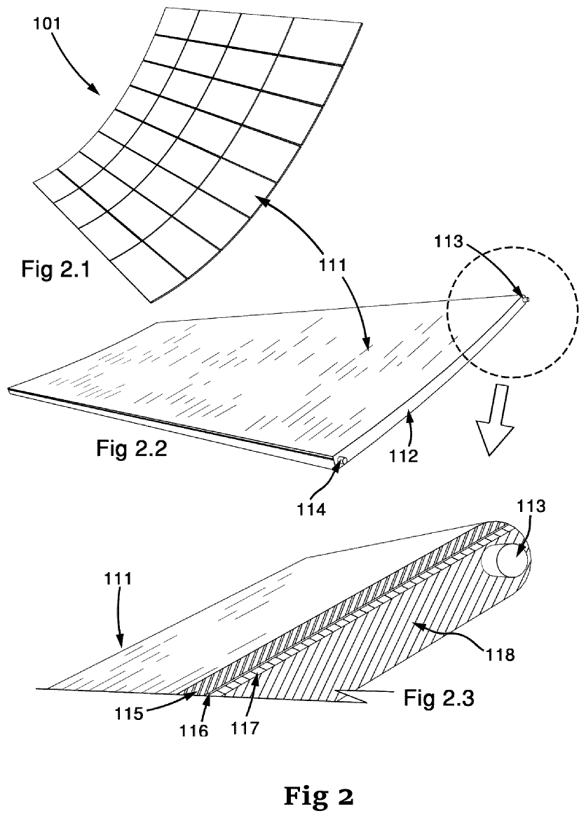

Conventional reflectors such as those in conventional trough designs are disadvantageous because of optical distortions created by forces which include thermal expansion and contraction. The Mirror Panel Array (MPA) 101 of the present invention substantially avoids these effects by dividing the reflector into panels or tiles as shown in FIG. 2.1, each panel of which is supported independently by pins 113 & 114. Slots 126 & 127 in the supporting ribs 120, and into which the pins fit, maintain the panels' proper optical alignment while also allowing the panels to expand and contract both laterally and longitudinally without being distorted by constriction.

Each mirror panel 102 is rectangular in plan, and has a curved cross-section which comprises a parabolic segment appropriate to the panel's position in the array. Along the length of the solar collector unit, each mirror panel 102 in an array is separated from adjacent panels by a support arm 120. Furthermore, across the width of solar collector unit, each panel 102 is separated from its adjacent panel by a narrow gap which allows for thermal expansion of the panels, and free movement of each panels during servicing or replacement.

Each mirror panel 102 has four guide-pins, two at the top 113, and two at the bottom 114. The pins are attached to the panel 102 with the aid of a stabilizing end cap 112, shown in FIG. 2.2. Each panel 102 may comprise several layers: a thin transparent protective layer 115, a reflective layer 116, and a weather-proof backing 118, which may include a metal layer 117. The transparent protective layer 115 may comprise a tough, very thin, transparent coating. As described above, all components of the mirrors are preferably fashioned from lightweight materials.

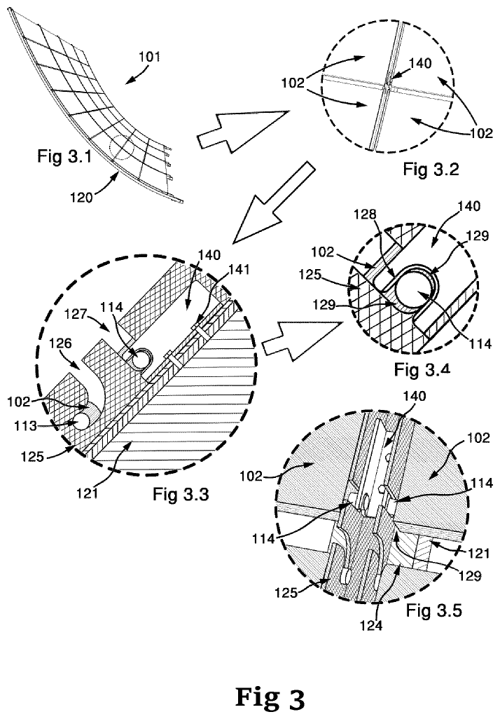

FIG. 3 shows embodiments of a support beam 120. The mirror panels 102 attach to the mirror constraint 125 as it is configured with guide pin slots 127, 126, which allow adjustment and replacement of any of the mirror panels 102. The top guide-pins 113 of each panel 102 slide into a J-slot 126, while the bottom guide pins 114 are held within the straight slot 127, and are constrained by a guide pin lock 140. Thermal expansion and contraction of the panels 102 are thereby freely permitted by the mirror expansion/contraction allowances 129, shown in FIG. 3.4, and by the gap provided between the panel 102 and the mirror constraint 125, as shown in FIG. 3.5.

This configuration allows the compound parabolic mirror 200 to avoid the various optical distortions of the reflectors that occur in conventional tightly constrained reflectors which are fixed rigidly to support structures.

The resting position of each top pin 113 is governed by the precise configuration and location of the J-slot 126. The J-slot 126 is a curved channel, which allows the panel to be secured simply by gravity, which will tend to pull the top pins 113 into the end of the J-slot 126.

The straight slot 127 and guide pin lock 140 may accommodate a U-shaped shim 128 which permits the panel's focus line to be precisely positioned. The shim 128 arms may have slightly different thickness, which alters the pin's position depending on the choice and/or positioning of the shim.

### Receiver and Concentration Techniques

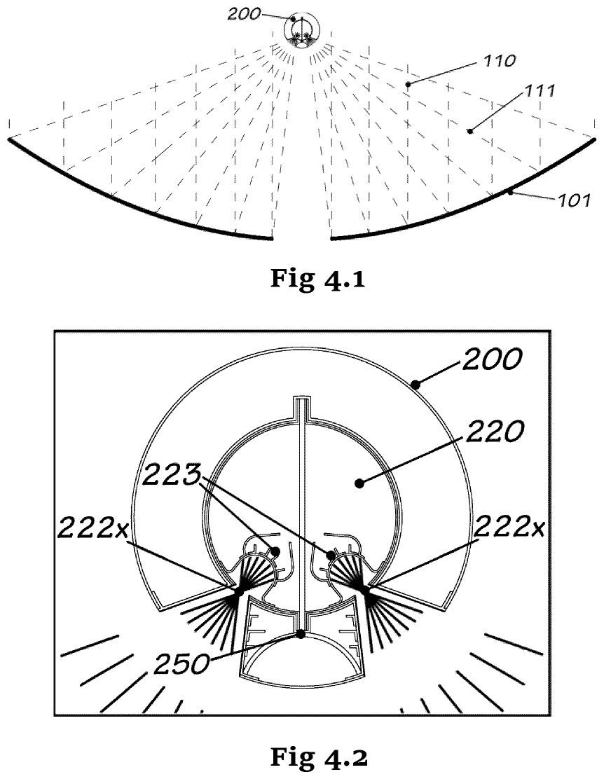

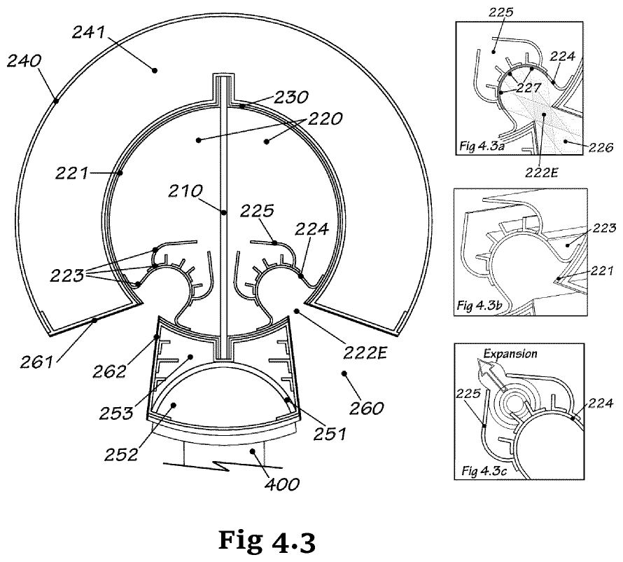

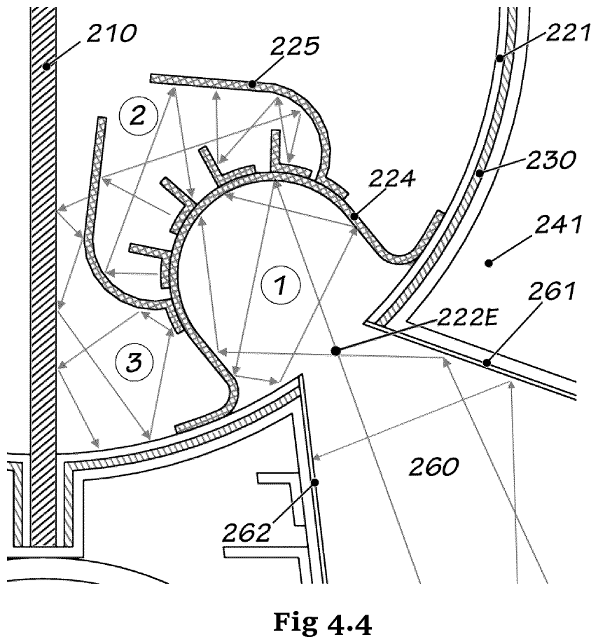

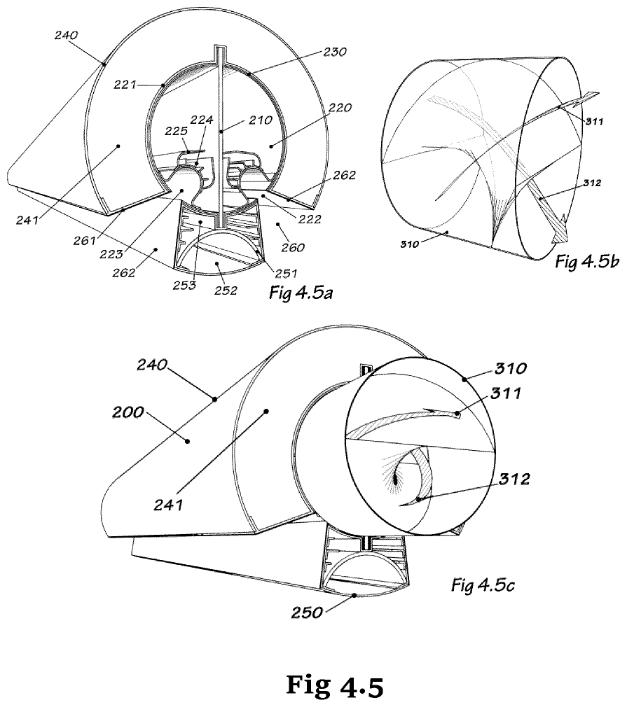

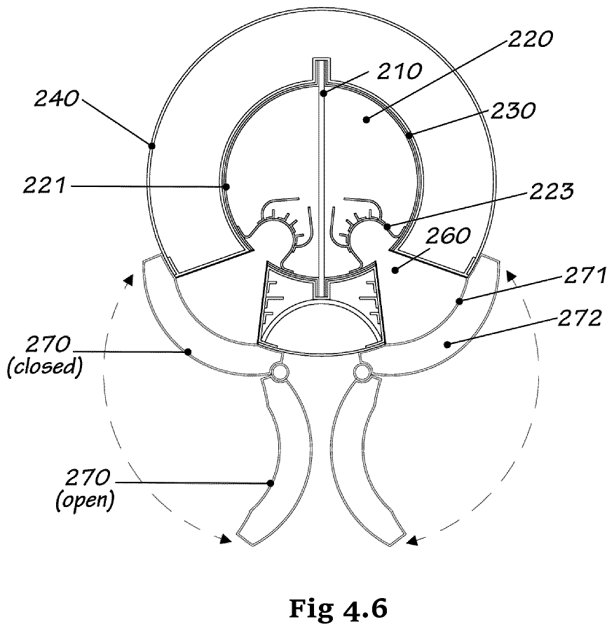

A generally cylindrical receiver 200, exemplified in FIG. 4.1, receives the reflected energy from the MPA 101 and heats the heat transfer fluid, a gas, carried in the Hot Pipe (HP) 220. Conventional, low-temperature solar concentration troughs are limited by the design of their receiver and the nature of the thermal oil heat transfer fluid. Use of a gas as the heat transfer fluid, together with the design of the collector, allow the solar collector unit 100 concentration levels—and therefore operating temperatures—to be significantly higher than prior art configurations.

The configuration of the receiver 200 FIG. 4.2 concentrates the light energy into the internal Hot Pipe (HP) 220, while also creating thermal barriers to reduce heat loss. The HP 220 may be coated or surrounded by a thin heat reflective wall 221, which in turn may be surrounded by an insulation layer.

In a preferred embodiment, the SCU 100 comprises opposing MPAs 101, with a single central receiver 200, as may be seen in FIGS. 1 & 4.1. The HP 220 will therefore comprise dual heat exchangers 223, as illustrated in FIGS. 4.2 & 4.3, to receive, concentrate, and deliver the solar energy from both sides into the HP 220.

Both heat exchangers 223 run inside the length of the HP and are semi-circular in cross-section. Each heat exchanger is sealed inside the HP, thereby cutting off the interior of the HP from outside air. FIG. 4.2 shows how intensely concentrated sunlight from the mirrors is thereby permitted to strike the interior of both heat exchangers, and how the heat exchanger's opposite side is in direct contact with the thermal fluid within the HP 220. The MPAs 101 will focus the reflected sun's image, or sunspot, as tightly as physically possible along a theoretical focal line 222X located in the middle of the Hot Pipe Entry 222E.

Generally, relatively cool heat transfer fluid flows down the Return Air Pipe RAP 250, absorbing some heat by conduction from the HP 220 in a manner to be explained, and upon reaching the end of the solar collection unit is redirected to flow through the HP 220, where it will be heated by a heat exchanging structure 223. Such redirection may constitute a reverse of the direction of fluid flow back through the Hot Pipe with which the RAP is paired in the construction of a specific receiver 200, or it may constitute an advancement in the same direction when two troughs are connected, end to end. In the latter case when the pair's two cooler return air streams converge at the centre of this combined trough, they would cross paths to feed their other half's Hot Pipe. This arrangement will allow a significant decrease in the pressure drop which would the case if the cooler air was forced into a 180 degree turn as would happen in the case of a single, stand-alone collector such as one located along the perimeter of a collection of troughs.

The receiver 200 defines a linear entry gap 222E for directing the focused solar radiation from the MPA 101 into the heat exchanger 223 positioned within the HP220. The entry gap is narrowest at the entry to the heat exchanger, and widens outward at an angle governed by the extremes of the incoming concentrated irradiation. The heat exchanger 223 is formed from a highly heat conductive material, such as a suitable metal.

The focal line 222X of the reflected insolation is placed within the entry gap to the heat exchanger, as shown in FIG. 4.2. The insolation irradiates the inside surface of the heat exchanger 223, which transfers heat to the thermal gas passing through the HP 220. The heat exchanger 223 preferably comprises heat transfer surface modifications, such as fins. The focal line 222X is preferably positioned precisely aligned with the trace of the circumference of the HP 220, as shown in FIG. 4.2, which allows for minimization of the width of the entry gap, and therefore losses to the environment. As the geometry shows, this is an optimum location as any significant deviation from it in any direction may increase these losses.

In summary, by delivering concentrated insolation to the interior of the heat exchanger 223, which is substantially surrounded by thermal fluid, operating conditions are very different from what happens in conventional CSP troughs where a relatively small receiver tube is bombarded by insolation on its entire exterior, but is thereby exposed to losses on all sides.

### The Heat Exchanger

The heat exchanger 223 applies the theory behind an optical integrating sphere (also known as an Ulbricht sphere), the fundamental principle of which is to admit concentrated and tightly focused radiation through a small entry into a cavity from which radiation has difficulty escaping. In some embodiments, the cavity is substantially cylindrical, and the entry is a narrow linear gap in its circumference running the full length of the heat exchanger. The narrower the gap is compared to the cylinder's cross-section at large, the smaller is the amount of heat lost to the surroundings, and the higher is the temperature that builds up within the cylinder.

In some embodiments, the heat exchanger 223 is a prism which may have a generally circular or round cross-section (i.e. generally cylindrical) and may have various surface modifications, such as fins as shown in FIGS. 4.2, 4.3, & 4.4. In a one embodiment, fins may run the length of the heat exchanger and may be arranged to form small sub-conduits connected to the larger body of the heat exchanger 223. These small conduits are open at their ends and to the main volume of the HP 220 through narrow gaps so as to allow the thermal fluid to pass freely in or out. They function as concentrators of heat energy by virtue of both conduction and radiation coming from neighbouring parts of the heat exchanger 223. In addition, because the gaseous fluid will undergo expansion, streams of heated air will be expelled into the HP 220 creating local mixing and higher temperatures within the HP 220 as a whole.

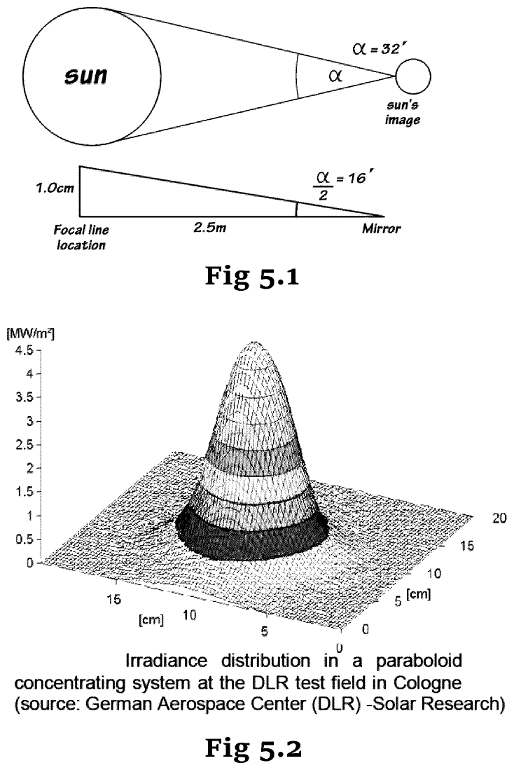

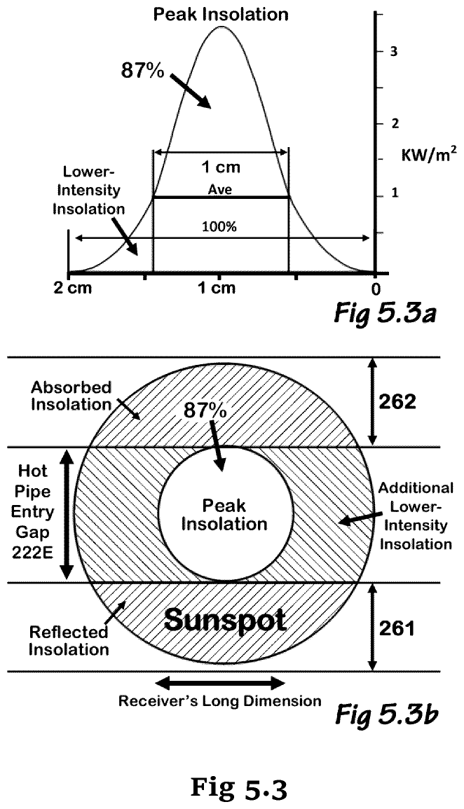

FIGS. 5.1 and 5.2 illustrate aspects of another phenomenon implicated in the design and method of the invention. High temperatures derived from solar radiation require that highly concentrated solar energy strike the surface of a heat exchanger. However, because the sun is not a point source of radiation, there are practical limits to the degree of its concentration. As it did not originate as a point, the sun's image can only be concentrated to a disc, or sunspot, with a finite diameter limited by the solar angle, a, as illustrated in FIG. 5.1.

The consequence is that, for example, if a theoretical focal line is 2.5 m from the mirror 101, the diameter of the sunspot will be about 2 cm. This sets the theoretical minimum width for any opening designed to permit the full amount of light reflected from an ideal mirror to pass through.

However, the flux within a sun-spot is not consistent across its diameter as is illustrated by FIG. 5.2. Thus, with cylindrical mirrors such as those in CSP troughs, FIG. 5.3 illustrates several points. As energy arrives at the mirrors' focus, almost 90% of the flux is concentrated in the central part of the sun-spot FIG. 5.3a. The peak insolation falls within a circle roughly half the diameter of the sun-spot. The most intense of the insolation is several times the average solar flux (generally roughly 1 kW/m²).

FIG. 5.3b demonstrates how reflected solar insolation, as represented by a single sun-spot image, may be directed at a cylindrical receiver with an entry gap, the HP Entry 222E, which runs the length of the receiver. It shows how in an ideal device, even though the sun-spot may be roughly twice the width of the Entry, most of its energy will be accepted into the receiver as part of the peak insolation. It also shows how of all the lower intensity insolation in the larger ring surrounding the peak intensity, roughly half that labeled as “additional low-intensity insolation” will also be admitted directly into the heat exchanger area. Finally, some of the low-intensity insolation shown in FIG. 5.3b is also captured by the action of the LEC side liners 261 and 262, as will be described below.

Constriction of the HP Entry 222E in order to select only a portion of the incoming solar insolation, and to increase the efficacy of the integrated cylinder heat exchanger, while using the high precision reflector described above in order to send as much highest intensity insolation as possible through the Entry 222E, are preferred features of the present invention as their combination is desired to achieve the highest efficiency in heat transfer from insolation to thermal fluid.

The entry ways in to the heat exchangers are defined by Light Entry Chambers (LEC) 260, as shown in FIG. 4.3, formed by the gap in the outer parts of the receiver allowing for the passage of the concentrated insolation. The combination of reflective and absorbent sides to the LECs help pre-heat air in the RAP 250 with otherwise wasted radiation caused in the reflective process, as will be explained.

Heat exchangers 223 comprise two conjoined but functionally distinct structures, the Concentrated Radiation Impact Surface (CRIS) 224, and the Channelled Air Stream Heater (CASH) 225. The CRIS comprises all those surfaces within the cylinder of the heat exchanger itself which are exposed to incoming radiation. The CASH comprises all those surfaces that are directly exposed to the thermal fluid within the HP 220, and are part of the heat exchanger. CRIS 224 and CASH 225 share the cylindrical, omega-shaped structure that forms the principal, structural component of the heat exchangers that bridges the Hot Pipe Entry 222E, and seals the heat exchanger 223 against the HP 220 walls. This distinction is made only to emphasize and clarify their different functions which sometimes must be balanced in order to achieve the best overall performance of the heat exchanger.

The CRIS receives the concentrated insolation 226 along the Impact Zone 227 FIG. 4.3a, some of which is re-radiated to adjacent CRIS surfaces or escapes back out the entry and most of which, in a preferred heat exchanger, is conducted to the CASH surfaces and fin-like components.

The CASH 225 surfaces and fin-like elements may partially enclose spaces within the Hot Pipe for the purpose of transferring heat via conduction to the passing thermal fluid while also irradiating neighbouring CASH surfaces so as to increase their temperature. This configuration can generate exceedingly hot streams of air very rapidly.

The behaviour and design of CASH 225 are governed at least by the nature of fast flowing gasses, by the temperature difference between the gas and the CASH metal surface (ΔT), by the size and nature of the area of contact between the metal and gas, and by radiation properties described by the Stefan/Boltzmann Law.

Lateral convection is very limited within gasses flowing fast along a duct, as they do within the HP, and radiation in and of itself does little to heat a gas. Conduction plays the dominant role in the transfer of heat with heat exchanger 223. This results in high gas temperatures being developed predominantly immediately adjacent to the metal surfaces of the CASH.

For the heat exchange to be effective, therefore, the input temperatures must be high, heat conduction to the exchanger must be rapid, the area of contact between metal and air in the exchanger must be high, and there must be a way to displace hot air next to the heat exchangers with cooler air to prevent the ΔT from becoming low.

The process of reaching a high input temperatures starts in the Impact Zone 227 (FIG. 4.3a). Its temperature is a function of the intensity of the solar energy flux striking the Zone, which in turn is dependent upon the total amount of energy passing through the Entry 222, and the degree of its concentration when it hits the Zone. The greater the distance from the Entry to the Impact Zone, the less the concentration and the lower the temperature that can be achieved. Conversely, the small that distance, the higher the CRIS temperature, but the greater the heat loss by radiation though the entry gap.

FIG. 4.3 shows a cross-section of one embodiment of a generally cylindrical receiver 200, with a generally cylindrical heat exchanger 223, with reasonably realistic scale. Assuming that the length of Impact Zone (227 in FIG. 4.3a) is about 4 cm as measured around its arc, and that the effective width of the mirror which would send concentrated insolation to the CRIS to be 3 m. Effective width is term known in the art and refers to a plane perpendicular to the incoming solar radiation; it defines the amount of radiation captured at any moment no matter the orientation of the collector in relation to the position of the sun. Then, with a perfect mirror, for every centimeter of length of the receiver module, about 300 cm² of insolation would be concentrated onto 4 cm² of Impact Zone, which is a ratio of 75:1. However, if the light were allowed to strike the far side of a 20 cm diameter duct, instead of being stopped by the heat exchanger, for example, that factor would drop to about 10:1, far less even than the concentrations sought in current lower temperature CSP trough applications. Thus, the CRIS and HP dimensions roughly of the proportions seen in FIG. 4.3 are preferred, as high concentrations lead to high temperatures.

Heat in the Impact Zone 227 is conducted through to the CASH 225. Different metals, such as alloys of copper and steel, have different abilities to conduct heat and have different limitations in high-temperature applications. A trough designed for a certain location may therefore involve different metals and shapes of components within the individual modules of the trough in order to achieve the best heat transmission. Nevertheless, the thermal conduction of metals increases with increasing temperature. Therefore, the greater the energy flux striking the Impact Zone, the higher the operating temperatures generally, the greater the conduction of heat onward to the CASH, and the greater the potential for high ATs generally.

To maximise the contact between heated metal surfaces and the gas, the CASH preferably comprises a plurality of fins 226 extending into the air stream which causes the output area of the CASH to be significantly larger than that of the Impact Zone of the CRIS.

The CASH further comprises wrap-around outer fins 227, as seen in FIGS. 4.3 & 4.4, which permits the heat exchanger to benefit from the Stefan/Boltzmann Law, which dictates that the strength of radiant energy emitted from a surface increases by the power of four with every degree increase in the temperature of that surface. Accordingly, CASH is preferably configured with fins which create confined spaces with both a large surface area and short distances between the radiating surfaces.

In one embodiment, exemplified in FIG. 4.4, has three distinct heat zones where this effect comes into play, each marked by a circled number.

The first zone, labeled 1 in FIG. 4.4, lies within the space enclosed by CRIS 224 and portions of the HP wall where radiant energy which does not escape through the Entry to the atmosphere is reflected back to the CRIS 224, thereby elevating and helping to maintain its temperature. This behaviour will be recognised by those familiar with the art as being an adaptation of the behaviour of an integrated sphere used in the optical sciences.

The second zone, labeled 2 in FIG. 4.4, lies in the interior of the CASH 225. By having curved outer fins or “arms”, a partially enclosed space is created and, much of its radiation is blocked from exiting the area. All CASH fins thereby engage in an exchange of radiation at close quarters. This radiation effect has a beneficial effect on the temperature of the metal of the arms as it augments the heat conducted from the CRIS directly along the CASH's fin arms.

These matters are relevant when considering the behaviour of metals such as steel and copper, where steel has a relatively low thermal conductivity but a higher melting point compared to copper. Boosting the temperature of steel fins may be required to reach desired air temperatures beyond those at which copper would melt. In some embodiments, the receiver may therefore use metals with a lower melting temperature like copper in the heat exchangers in receiver modules at the beginning, low-temperature end of a trough, and steel or suitable alloys at the high-temperature end.

The third zone, labelled 3 in FIG. 4.4, lies between the exterior of the heat exchanger as a whole and the receiver's central load-bearing beam 210. Heated air in Zones 2 and 3, FIG. 4.4 each help to heat the beam 210 itself, which heat is conducted to the air in the upper reaches of the HP. They also combine to create currents of heated air which expand outward of the CASH structure, as illustrated in FIG. 4.3c. These hot currents tend to establish clockwise and counter clockwise streams in their respective sides which help with mixing the heat transfer fluid by pushing relatively cooler air around the HP down to the heat exchangers. However, the principal role for the two zones is that they create localised streams of super heated air which are propelled longitudinally along the HP.

### Helical Airflow Inverter (AFI) 360

As the streams of super heated air just mentioned become hotter, the ΔT between the fluid and the heat exchangers reduces. Thus, it is preferred to bring in cooler air from the upper portion of the HP to replace the hot air concentrated in the CASH area. This may be done by segmenting the heat exchangers within a receiver module and adding baffles or diverters, or other static mixers (not illustrated). In preferred embodiments, a mixer, such as a Helical Airflow Inverter 310 shown in FIG. 4.5, is placed between the receivers of adjacent SCUs 100 as suggested in FIG. 4.5. Also, in a preferred embodiment, coupling units (not illustrated) are associated with and surround the Inverter, and connect the receiver modules to form a continuous receiver which extends the full length of the collector.

FIG. 4.5b shows how the High-Temperature Side 311 takes the hot streams coming off the heat exchangers and guides them to the opposite side of the HP. The Low-Temperature Side 312 simultaneously feeds cooler air onto the heat exchangers in the next module, which immediately creates an increase in the ΔT and in the performance of the trough.

### Central Load Bearing Beam

Receiver modules 200 are preferably both rigid and light-weight in order to bridge the space between receiver supports 400 and maintain as precisely as possible the relative positions of the heat exchangers 223 and the mirrors' two focal lines 222X. In a preferred embodiment, a Central Load-bearing beam 210 divides the HP 220 into two structurally sound halves, while also delivering the load to the Return Air Pipe (RAP) 250 below and onward to the collector's support structure.

### Return Air Pipes

In some embodiments, Return Air Pipe 250 is a structural beam for the receiver and is designed to carry most or all the physical load of the receiver in such a way as to avoid any sagging. Sagging creates divergence of the focal lines from their preferred precise positioning within the Entry gap, an effect which would increase rejection of concentrated irradiance. To prevent sagging, the Central Load Bearing beam 210 carries the receiver's load and delivers it to the Central Beam Support Arch 251 within the RAP, which in turn transmits it to the Receiver Support 400 (FIGS. 1.1 & 4.3). The RAP, having a relatively small cross-section compared to the receiver as a whole, may be robustly built. The average operating temperature of the RAP will be consistently much lower than that of the Hot Pipe which helps to maintain rigidity. The preferred configuration shown in FIG. 4.3 keeps the receiver as a whole both lighter and lower in material costs.

The RAP's second important function is to pre-heat air returning to the receiver from the system by capturing heat which might otherwise be lost. Heat may be captured as it escapes from the HP 220 through various components, such as the Beam 210 and through the Insulative Layer 230, which surrounds the HP and separates it from the RAP.

In addition, the RAP collects heat from insolation reflected and absorbed by the sides of the Light Entry Chambers (LECs) 260 (FIG. 4.4). This light comprises sunspot radiation which does not pass directly through the chosen gap (shown in FIGS. 4.4 and 5.3), and stray radiation from the collector as a whole. Liners 261 and 262 cover sides of the LECs and act in pairs. Radiation which hits the reflecting liner 261 is generally directed either to the interior of the heat exchanger, or toward the absorbing liner 262, where it doubles up with stray radiation striking the absorbing liner directly. Heat conducts through the absorbing liner 262 and the fins in the upper return air pipe 250 (FIG. 4.3) to the returning air.

### Receiver Support

Given that the thermal fluid is a gas in order for the collector to produce the necessary output, and that gasses, including air, have a low capacity to carry heat, the diameter of the HP should be large relative to the heat exchanger 223 to carry sufficient volumes. However, such a large diameter receiver casts a shadow wide enough to make a continuous, symmetrical parabolic mirror impractical and requires the mirror to be split (FIGS. 1.1 & 4.1). This geometry allows the receiver to be supported from within the shadow by the Receiver Support 400.

### Light Entry Chamber Caps

As the heat exchanger will have operating temperatures in the high hundreds of degrees Celsius, heat shock may be a concern at times when the heat exchangers are exposed to sudden, large temperature swings, such as when a cloud blocks the sun for a prolonged time during active collecting. Efficiency is also compromised at such times since the receiver as a whole loses heat through the Light Entry Chambers 260 (FIG. 4.6) and may need to be brought back up to operating temperature when the sun reappears. Thus, Light Entry Chamber Caps 270 with reflective metal sleeves 271 and insulation 272 are placed along each receiver to mitigate these problems.

Finally, all CSP collectors suffer from end effects at times when the sun is at an angle to the collector such that the arriving insolation is reflected to the extension of the Focal Line 112 beyond the receiver, and when, at the opposite end of the receiver, the insolation starts striking the receiver some distance from its end. Short, contiguous Caps in these locations, and receivers appropriately longer than the reflectors when necessary, may improve the troughs' efficiency significantly.

### Solar Collector Units' Orientation

Because of their overall high efficiency of irradiance collecting, SCUs may be orientated either N-S or E-W, depending on the location's latitude and local conditions, while tracking the sun's azimuth or elevation, respectively. The former is favoured in areas approaching the tropics, the latter in areas further north. Each mode has distinctive advantages and disadvantages associated with the speed with which the earth's rotation governs the manner in which the sun arcs across the sky. This degree of flexibility in orientation is not practically available with conventional CSP trough designs.

### Aspects

In view of the described devices, systems, and methods and variations thereof, certain more particularly described aspects of the invention are presented below. These particularly recited aspects should not however be interpreted to have any limiting effect on any different claims containing different or more general teachings described herein, or that the “particular” aspects are somehow limited in some way other than the inherent meanings of the language literally used therein.

Aspect 1—A solar energy collection system comprising:
(a) an elongate solar collector unit comprising a horizontally elongate, hemi-parabolic mirror having a linear focus line;
(b) an elongate receiver having at least one linear gap which lies along the focus line of the reflector, and comprising a heat pipe and at least one heat transfer structure to heat a heat transfer fluid within the heat pipe with solar energy; and
(c) a subsystem configured to move a heat transfer fluid through the receiver.

Aspect 2. The system of aspect 1, wherein the heat transfer structure comprises a concentrated radiation impact surface (CRIS) for receiving the solar energy and a channelled air stream heater (CASH) comprising a surface for transferring heat energy to the heat transfer fluid.

Aspect 3. The system of aspect 2 wherein the CRIS and the CASH comprise surfaces on either side of a heat tolerant cylinder have a “U” shaped cross-section whose purpose is to seal the heat pipe from ambient air.

Aspect 4. The system of aspect 2 or 3 wherein the CASH comprises a pair of curved outer fins defining a partially enclosed volume, and optionally at least one central fin disposed within the partially enclosed volume.

Aspect 5. The system of any one of aspects 1-4 wherein the receiver comprises two linear gaps, and two heat transfer structures, disposed on opposing sides of a vertical center line through the receiver and heat pipe.

Aspect 6. The system of aspect 5 further comprising a central supporting beam, positioned on the vertical center line and dividing the heat pipe into lateral halves.

Aspect 7. The system of any one of aspects 1-6, further comprising a return air pipe for delivering heat transfer fluid to the heat pipe.

Aspect 8. The system of aspect 7 wherein the Return Air Pipe is configured to support the receiver.

Aspect 9. The system of aspect 8 wherein the Return Air Pipe comprises an internal arch structure.

Aspect 10. The system of any one of aspects 1-9, wherein the receiver comprises at least one insulating layer and/or a reflective layer to reduce conductive and radiant heat loss from the heat pipe.

Aspect 11. The system of any one of aspects 1-10 wherein the heat transfer fluid is a gas, such as nitrogen or air.

Aspect 12. The system of any one of aspects 1-11 wherein the receiver comprises a plurality of heat transfer units, connected longitudinally end-to-end.

Aspect 13. The system of any one of aspects 1-12 further comprises elements within the heat pipe to mix the heat transfer fluid within the heat pipe.

Aspect 14. A solar energy collection system comprising any combination of feature or elements described herein or specified in any one of aspects 1-13.

Aspect 15. A solar energy receiver, configured to receive solar energy from a parabolic reflector which creates a linear focal line, the receiver comprising:
(a) a heat pipe defining a central hot gas flow path, having a central vertical support beam and defining at least one linear gap;
(b) a support structure supporting a lower edge of the support beam;
(c) a semi-cylindrical radiation receiver having an external surface for absorbing solar energy, the receiver aligned with the linear gap to create an insolation plenum along the length of the heat pipe;
(d) a heat transfer structure attached to an internal surface of the receiver, the structure comprising a plurality of heat transfer fins projecting into the heat pipe, preferably with outer fins which curve towards each other to form a partially enclosed space between them.

Aspect 16. The solar energy receiver of aspect 15, which is configured to receive solar energy from a symmetrical array of opposing parabolic reflectors which each create a linear focus line, and the heat pipe defines two linear gaps on either side of the support beam, which support beam divides the heat pipe into halves.

Aspect 17. A solar energy receiver configured to receive solar energy from a parabolic reflector which creates a linear focal line, the receiver comprising any combination of features or elements described herein.

### Definitions and Interpretation

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will also be understood by one skilled in the art, all ranges described herein, and all language such as “between”, “up to”, “at least”, “greater than”, “less than”, “more than”, “or more”, and the like, include the number(s) recited and such terms refer to ranges that can be subsequently broken down into sub-ranges.

1-15. (canceled)

16. A solar energy collection system comprising:
(a) an elongate solar collector unit comprising a horizontally elongate, hemi-parabolic mirror having a linear focus line configured to concentrate reflected solar radiation;
(b) an elongate receiver having at least one linear gap which lies along the focus line of the reflector, the elongate receiver comprising a heat pipe configured to retain a thermal fluid, and the receiver further comprising at least one heat transfer structure to heat the thermal fluid within the heat pipe with the solar radiation,
wherein the heat transfer structure comprises a Concentrated Radiation Impact Surface (CRIS) for receiving the concentrated solar radiation, and a Channeled Air Stream Heater (CASH) attached to the CRIS and having a surface for transferring heat energy to the thermal fluid,
wherein the CASH comprises at least one pair of outer fins projecting into the heat pipe, and defining a partially enclosed volume within the heat pipe; and
(c) a subsystem configured to move the thermal fluid through the receiver.

17. The system of claim 15, wherein the CRIS and the CASH comprise surfaces on either side of a trough member, the CRIS comprising a curved portion of which extends into an interior of the heat pipe, and which is sealingly attached to an inside surface of the heat pipe, wherein the CRIS and CASH are aligned along the at least one linear gap.

18. The system of claim 15, wherein the at least one pair of outer fins comprise unattached longitudinal edges that are displaced towards one another so as to define the partially enclosed volume, and preferably comprise a pair of curved outer fins.

19. The system of claim 15, wherein the CASH further comprises at least one central fin disposed within the partially enclosed volume.

20. The system of claim 15, wherein the receiver comprises two linear gaps, and two heat transfer structures, disposed on opposing sides of a vertical center line through the receiver and heat pipe.

21. The system of claim 19, further comprising a central supporting beam positioned within the heat pipe, and dividing the heat pipe into lateral halves.

22. The system of claim 15, further comprising a return air pipe for delivering the thermal fluid to the heat pipe.

23. The system of claim 21, wherein the return air pipe is configured to support the receiver.

24. The system of claim 15, wherein the receiver comprises at least one insulating layer and/or a reflective layer to reduce conductive and radiant heat loss from the heat pipe.

25. The system of claim 15, wherein the thermal fluid is a gas.

26. The system of claim 24 wherein the thermal gas is nitrogen or air.

27. The system of claim 15, wherein the receiver comprises a plurality of heat transfer units, connected longitudinally end-to-end.

28. The system of claim 15, further comprising elements within the heat pipe to mix the thermal fluid within the heat pipe.

29. A solar energy receiver, configured to receive solar energy from a parabolic reflector which creates a linear focal line, the receiver comprising:
(a) a heat pipe defining a central hot gas flow path, having a central vertical support beam and defining at least one linear gap;
(b) a support structure supporting a lower edge of the support beam; and
(c) a semi-cylindrical trough within the heat pipe, defining a plenum along a length of the heat pipe and aligned with the linear gap, wherein the trough comprises a first surface directed towards the one linear gap, and an opposing second surface;
(d) a heat transfer structure attached to the second surface of the trough, the structure comprising at least one pair of heat transfer fins projecting into the heat pipe, with a partially enclosed volume defined between the fins and inside the heat pipe.

30. The solar energy receiver of claim 28, which is configured to receive solar energy from a symmetrical array of opposing parabolic reflectors which each create a linear focus line, and the heat pipe defines two linear gaps on either side of the support beam, which support beam divides the heat pipe into halves.

31. The solar energy receiver of claim 28, wherein the at least one pair of heat transfer fins comprise unattached longitudinal edges that are displaced towards one another so as to define the partially enclosed volume, and preferably comprise a pair of curved fins.

32. The solar energy receiver of claim 29, wherein the at least one pair of heat transfer fins comprise unattached longitudinal edges that are displaced towards one another so as to define the partially enclosed volume, and preferably comprise a pair of curved fins.
